(19) United States
(12) Patent Application Publication
(10) Pub. No.: US 2026/0021645 A1
(43) Pub. Date: Jan. 22, 2026

(54) NESTED LAYERS IN BEDDING OR SEATING PRODUCT

(71) Applicant: L&P Property Management Company, Carthage, MO (US)

(72) Inventors: Bruce W. Peterson, Jacksonville Beach, FL (US); Jason V. Jewett, Carthage, MO (US)

(21) Appl. No.: 19/238,693

(22) Filed: Jun. 16, 2025

Related U.S. Application Data
(63) Continuation-in-part of application No. 18/778,269, filed on Jul. 19, 2024.

(51) Int. Cl. B32B 5/32; B32B 3/30; B32B 7/022; B32B 7/09

(52) U.S. Cl. CPC B32B 5/32; B32B 3/30; B32B 7/022; B32B 7/09; B32B 2250/02; B32B 2250/22; B32B 2305/34

(57) ABSTRACT

A bedding or seating product comprises a first layer having a patterned first surface nested with a patterned surface of a second layer to create a transition zone between the first and second layers. The layers may be sewn together. Each patterned surface comprises peaks and valleys. Air channels may be created in the transition zone if the peaks and valleys of one layer are a different height than the peaks and valleys of the other layer.

### CROSS REFERENCE TO RELATED APPLICATIONS

This application is a continuation-in-part of U.S. patent application Ser. No. 18/778,269 filed Jul. 19, 2024, which is fully incorporated by reference herein.

### FIELD OF THE INVENTION

This invention relates generally to bedding and seating products and, more particularly, to bedding and seating products having multiple nested foam layers.

### BACKGROUND OF THE INVENTION

Mattress spring core construction over the years has been a continuously improving art with advancements in materials and machine technology. A well-known form of spring core construction is known as a Marshall spring construction wherein metal coil springs are encapsulated in individual pockets of fabric and formed as elongate or continuous strings of pocketed coil springs. These strings of coil springs are commonly manufactured by folding an elongate piece of fabric in half lengthwise to form two plies of fabric and ultrasonically welding transverse and longitudinal seams to join the plies of fabric to define pockets within which the springs are enveloped.

Once strings of pocketed springs are constructed, they are assembled to form a pocketed spring core for a mattress, cushion or the like by a variety of methods. For example, multiple or continuous strings may be arranged in a row pattern corresponding to the desired size and shape of a mattress or the like, and adjacent rows of strings may be interconnected by a variety of methods. The result is a unitary assembly of pocketed coil springs.

Conventional mattresses incorporating pocketed spring assemblies have multiple layers of foam on one or both sides of the pocketed spring core. The foam layers are commonly glued together. The glue or adhesive is costly and may inhibit airflow through the product. The present invention eliminates the undesirable need to glue the foam layers together, thus reducing manufacturing costs and improving airflow.

Therefore, there remains a need to combine multiple technologies to reduce the manufacturing costs of a bedding or seating product having nested pieces of foam.

There is further a need for a mattress having improved airflow due to an absence of adhesive.

There is further a need for a mattress having air channels extending between foam pieces.

### SUMMARY OF THE INVENTION

In one aspect, a bedding or seating product is provided. The product comprises a pocketed spring core comprising a plurality of parallel strings of pocketed springs, each string being joined to at least one adjacent string. Any other known pocketed spring core may be used.

The bedding or seating product further comprises a first piece of foam having a flat surface proximate the pocketed spring core and peaks and valleys on the opposite side of the first piece of foam. The bedding or seating product further comprises a second piece of foam having peaks and valleys on one side of the second piece of foam nested with the peaks and valleys of the first piece of foam. The first and second pieces of foam may be made of different foams and may have different firmness.

The first and second pieces of foam may be sewn together using the apparatus and methods disclosed in U.S. Pat. Nos. 11,015,274 and 11,015,275, which are fully incorporated by reference herein.

The peaks and valleys of one of the foam pieces may be a different height than the peaks and valleys of the other foam piece to create air channels therebetween to increase airflow and cool the temperature of the product after being subjected to a load.

Cushioning materials including the first and second pieces of foam may be placed on the pocketed spring core, and a covering, usually an upholstered covering, encases the pocketed spring core and cushioning materials.

The peaks and rounded valleys may extend longitudinally (from end-to-end) or transversely (from side-to-side). A bedding or seating product may be posturized into regions or zones of different firmness by incorporating nested pieces of foam into the product having peaks and valleys of different heights.

At least one of the pieces of foam may contain at least one of the following additives: phase change materials, plant-based fibers, synthetic fibers, fragrances, slow-release fragrances, organic and inorganic antimicrobial additives, color additives, thermochromic materials, conductive additive solids, powders, particles, flakes, density reducing agents or gas generating materials. Such additives may impart different properties to the foam layers or pieces such as firmness, for example. The additives may be in the form of conductive solids, powders, particles or flakes.

In another aspect, a bedding or seating product having a core is provided. The core may be a foam core or a pocketed spring core.

The bedding or seating product further comprises a first piece of foam having a flat surface proximate the pocketed spring core and rounded peaks and rounded valleys on the opposite side of the first piece of foam. The bedding or seating product further comprises a second piece of foam having rounded peaks and rounded valleys on one side of the second piece of foam nested with the rounded peaks and rounded valleys of the first piece of foam. The first and second pieces of foam may be made of different foams and may have different firmnesses. The rounded peaks and rounded valleys may extend linearly or in a zig-zag shape/pattern or wave shape/pattern. The rounded peaks and rounded valleys may extend transversely or longitudinally.

The first and second pieces of foam may be sewn together in any of the embodiments shown or described herein. The sewn seams may extend transversely or longitudinally.

The rounded peaks and rounded valleys of one of the foam pieces may be a different height than the rounded peaks and rounded valleys of the other foam piece to create air channels therebetween to increase airflow and cool the temperature of the product after being subjected to a load.

At least some of the foam pieces may contain at least one of the following additives: phase change materials, plant-based fibers such as cellulose, cotton, hemp, linen, jute, wool and the like, synthetic fibers including carbon fiber, nylon, olefin, acrylic, polyester, rayon, vinyon, spandex, vinalon, aramids, Modal, PBI, Orlon and the like, fragrances including slow-release fragrances, organic and inorganic antimicrobial additives such as zinc omadine, N-Butyl-1,2-Benzisothiazonlin-3-one, OIT (2-n-Octyl-4-isothiazolin-3-one, 3-(Trimetholyxysily)proplydimethyloctadecyl ammonium chloride, copper and silver and the like, color additives, thermochromic materials, conductive additive solids, powders, particles, flakes such as activated carbon, carbon nanotubes, graphene, graphite, aluminum powder, silicon carbide, diamond dust and the like may be incorporated into the material. Density reducing agents such as fumed silica or gas generating materials may be added too.

In another aspect, a bedding or seating product is made without a pocketed spring core. The product comprises a first piece of foam having a flat surface and rounded peaks and rounded valleys on the opposite side from the flat surface. The product further comprises a second piece of foam having rounded peaks and rounded valleys nested with the rounded peaks and rounded valleys of the first piece of foam. The first and second pieces of foam may be sewn together using any known sewing method.

At least some of the pieces of foam may contain at least one of the following additives: phase change materials, plant-based fibers, synthetic fibers, fragrances, slow-release fragrances, organic and inorganic antimicrobial additives, color additives, thermochromic materials, conductive additive solids, powders, particles, flakes, density reducing agents or gas generating materials.

One advantage of the present invention is that when a bedding or seating product, such as a mattress, is manufactured, the manufacturer need not purchase adhesive, which may be expensive.

Another advantage of the present invention is that the bedding or seating product, such as a mattress, may impart a cooler “feel” to the user of the bedding or seating product than conventional products.

The accompanying drawings, which are incorporated in and constitute a part of this specification, illustrate embodiments of the invention and, together with the summary of the invention given above, and the detailed description of the drawings given below, serve to explain the principles of the present invention.

### BRIEF DESCRIPTION OF THE DRAWINGS

FIG. 1 is a perspective view, partially broken away, of a single-sided bedding product incorporating a pocketed spring core and a cushion comprising nested first and second layers of foam, the rounded peaks and rounded valleys extending transversely.

FIG. 1A is a perspective view, partially broken away, of a single-sided bedding product incorporating a foam core and a cushion comprising nested first and second layers of foam, the rounded peaks and rounded valleys extending transversely.

FIG. 1B is a perspective view, partially broken away, of a double-sided bedding product incorporating a pocketed spring core and a first cushion comprising nested first and second layers of foam above the pocketed spring core and a second cushion comprising nested first and second layers of foam below the pocketed spring core.

FIG. 1C is a perspective view, partially broken away, of another single-sided bedding product incorporating the pocketed spring core of FIG. 1 and a cushion comprising nested first and second layers of foam, the rounded peaks and rounded valleys extending longitudinally.

FIG. 1D is a perspective view, partially broken away, of another double-sided bedding product incorporating a pocketed spring core and upper and lower cushions, each cushion comprising nested first and second layers of foam, the rounded peaks and rounded valleys extending longitudinally.

FIG. 2 is an enlarged cross-sectional view of the first and second layers of foam spaced apart.

FIG. 2A is an enlarged cross-sectional view of the first and second layers of foam of FIG. 2 in a nested configuration.

FIG. 3 is a perspective view of a cushion comprising first and second convoluted foam layers nested together, the foam layers having wave or zig-zag shaped convolutions.

FIG. 3A is a perspective view, partially separated, of the foam cushion of FIG. 3 showing the wave or zig-zag shaped convolutions with rounded peaks and valleys extending in a wave or zig-zag pattern.

FIG. 3B is a perspective view of the lower foam layer of the foam cushion of FIG. 3 showing the wave or zig-zag shaped convolutions with rounded peaks and valleys extending in a wave or zig-zag pattern.

FIG. 4 is a perspective view, partially broken away, of another embodiment of single-sided bedding product made without pocketed springs and comprising two pieces of foam having nested rounded peaks and rounded valleys extending transversely and being linear.

FIG. 4A is a perspective view, partially broken away, of another embodiment of single-sided bedding product made without pocketed springs and comprising two pieces of foam having nested rounded peaks and rounded valleys extending longitudinally and being linear.

FIG. 5 is a perspective view, partially broken away, of another embodiment of single-sided bedding product made with pocketed springs and the two layers of nested foam having additives, the rounded peaks and rounded valleys extending transversely and linearly.

FIG. 5A is a perspective view, partially broken away, of another embodiment of single-sided bedding product made with pocketed springs and the two layers of nested foam having additives, the rounded peaks and rounded valleys extending longitudinally and linearly.

FIG. 6 is a top view of an alternative bedding product.

FIG. 6A is a cross-sectional view of the bedding product of FIG. 6.

FIG. 7 is a top view of an alternative bedding product.

FIG. 7A is a cross-sectional view of the bedding product of FIG. 7.

FIG. 8 is a top view of an alternative bedding product.

FIG. 8A is a cross-sectional view of the bedding product of FIG. 8.

FIG. 9 is a perspective view, partially broken away, of another embodiment of single-sided bedding product having a foam construction or cushion as shown in FIG. 9A.

FIG. 9A is a cross-sectional view of the multi-layer cushion of FIG. 9.

FIG. 10 is a perspective view, partially broken away, of another embodiment of single-sided bedding product having a foam construction or cushion as shown in FIG. 10A.

FIG. 10A is a cross-sectional view of the cushion of FIG. 10.

FIG. 11 is a graph showing a comparison of a mattress having a nested cushion in accordance with the present invention and a conventional mattress.

FIG. 12 is a perspective view, partially broken away, of another single-sided bedding product incorporating the pocketed spring core of FIG. 1 and a cushion comprising nested first and second layers of foam, the rounded peaks and rounded valleys extending transversely.

FIG. 13 is a perspective view of a cushion comprising first and second convoluted foam layers nested and sewn together.

FIG. 14 is a cross-sectional view of the multi-layer cushion of FIG. 13 taken along the line 14-14.

FIG. 14A is an enlarged side elevational view of a chain stitch being made in accordance with the present invention.

FIG. 15 is a perspective view of a cushion comprising first, second and third convoluted foam layers nested and sewn together.

FIG. 16 is a cross-sectional view of the multi-layer cushion of FIG. 15 taken along the line 16-16.

FIG. 17 is a perspective view of a cushion comprising first and second convoluted foam layers nested and sewn together.

FIG. 18 is a cross-sectional view of the multi-layer cushion of FIG. 17 taken along the line 18-18.

### DETAILED DESCRIPTION OF THE INVENTION

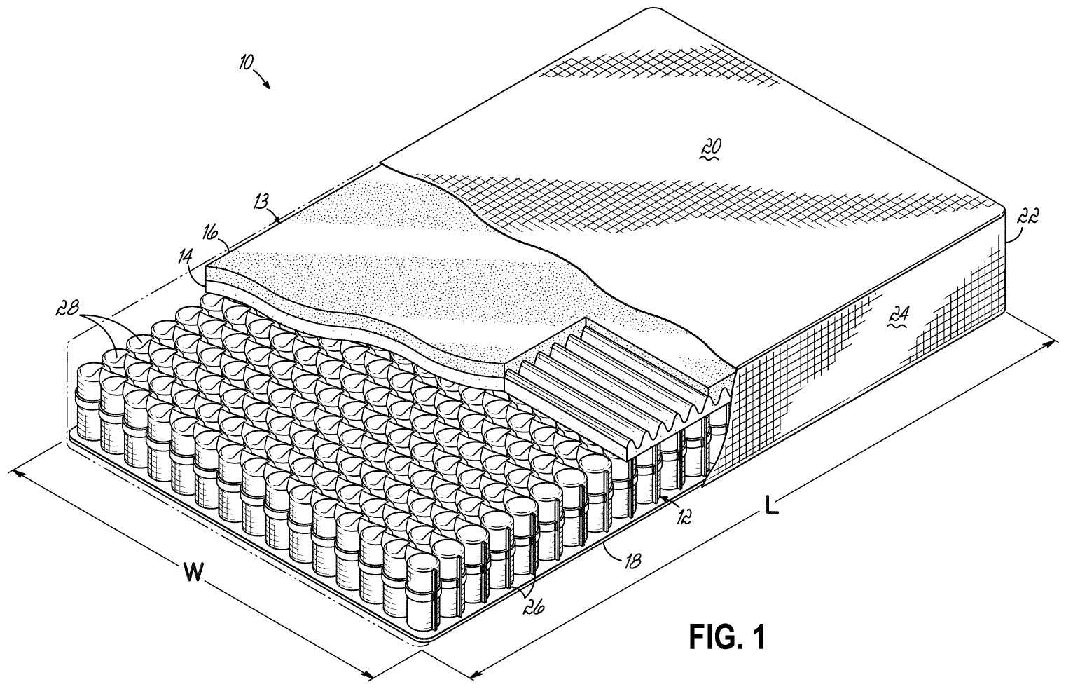

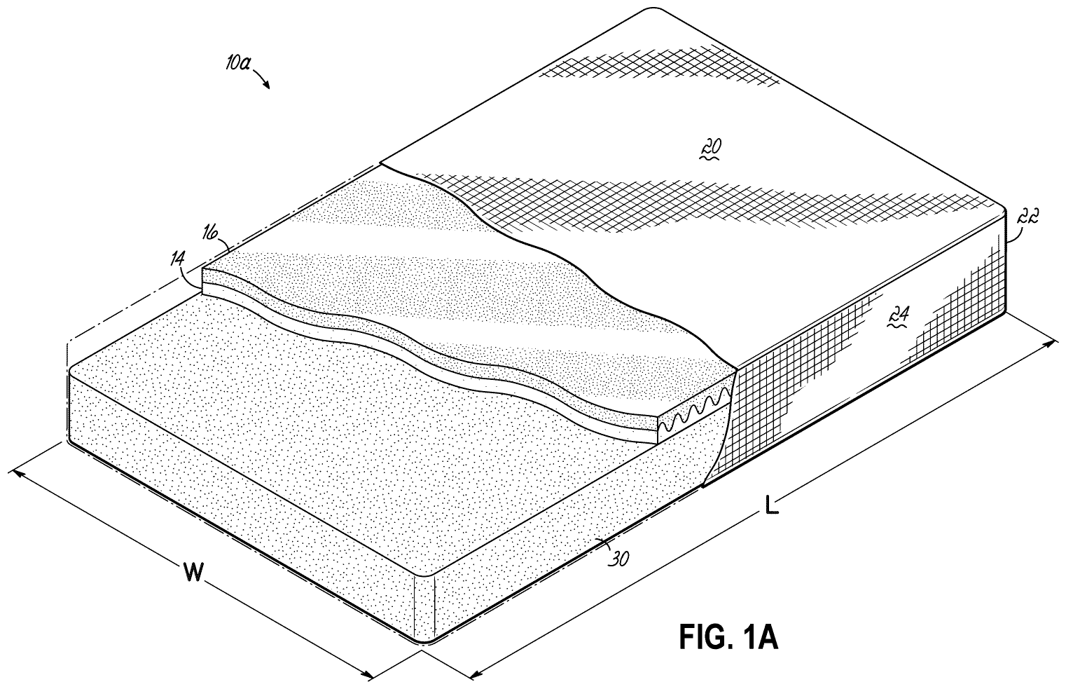

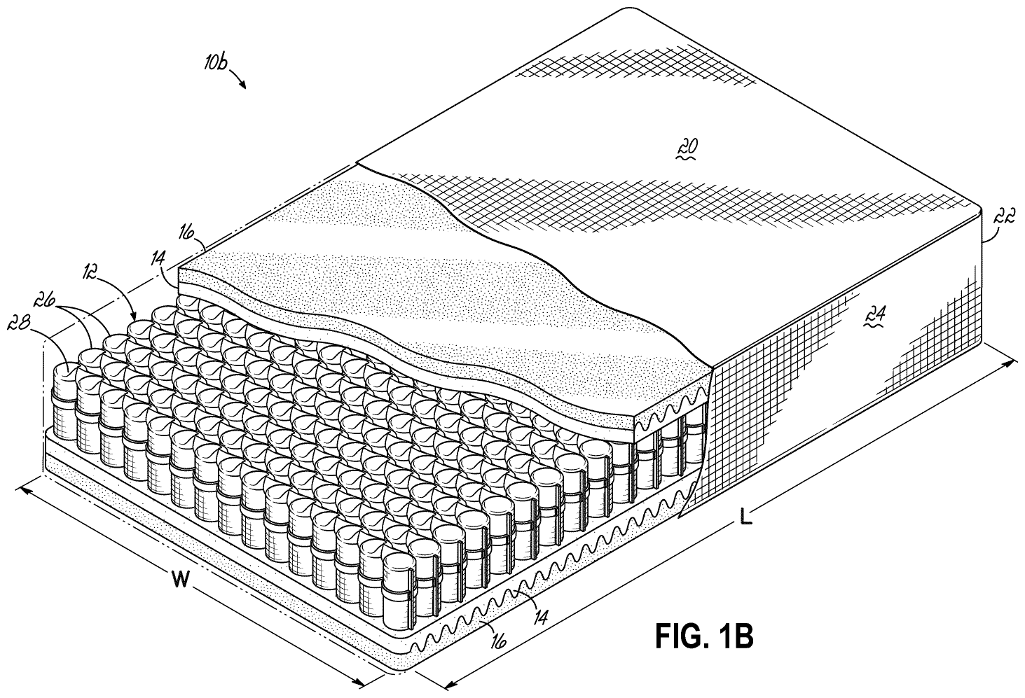

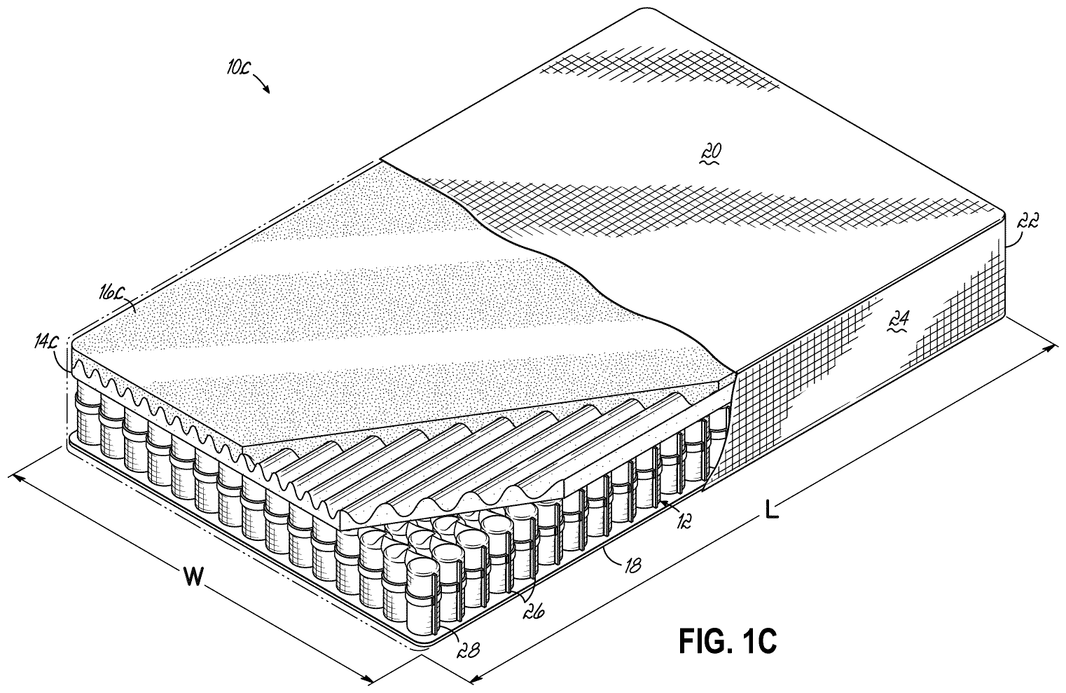

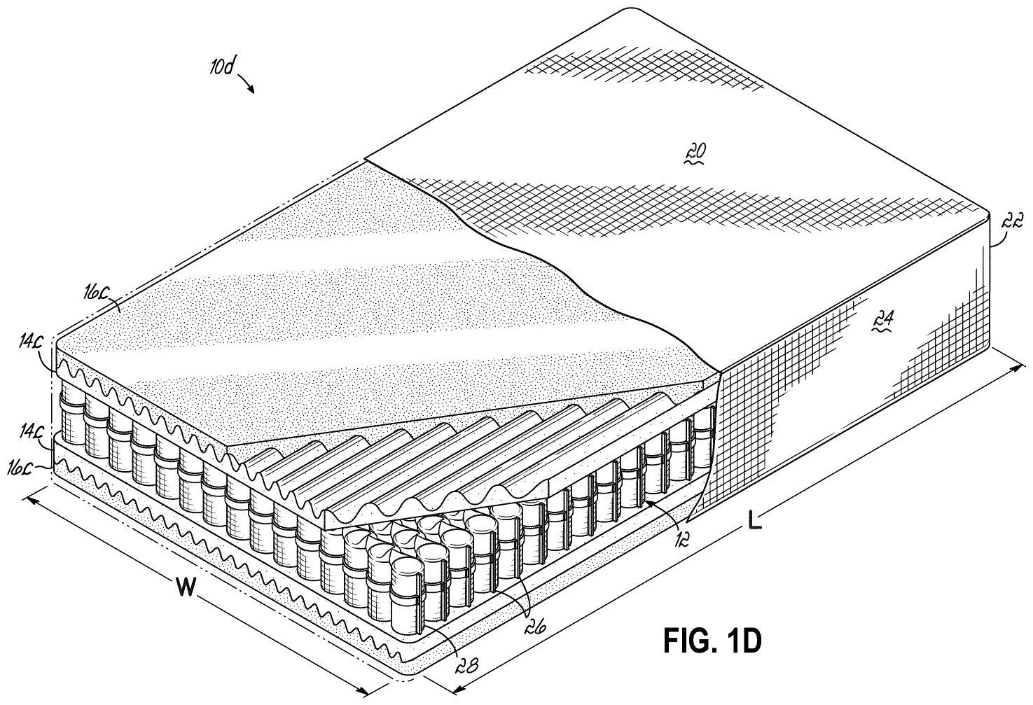

Referring to FIG. 1, there is illustrated a bedding product in the form of a single-sided mattress 10. This product or mattress 10 comprises a pocketed spring core 12 over the top of which there lay a cushion 13. The cushion comprises first and second convoluted foam layers 14, 16 nested together. The first or inner convoluted foam layer 14 may be made of the same foam or a different foam than the second or outer convoluted foam layer 16. Although each convoluted foam layer is shown as a single piece of foam, any of the foam layers may be made from multiple pieces of foam in any embodiment shown or described herein. Cushion 13 may be used in any of the bedding or seating products shown or described herein.

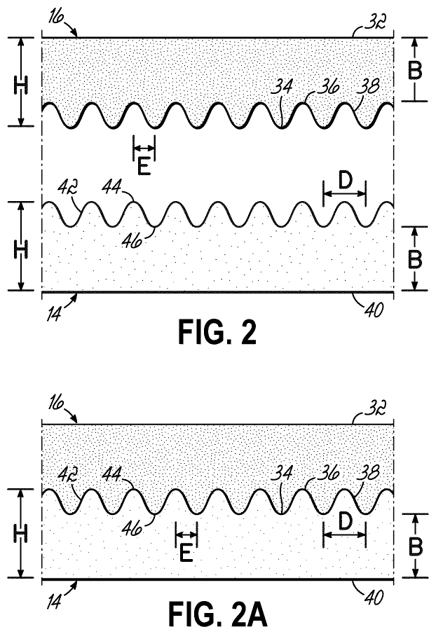

FIGS. 2 and 2A show the details of the convoluted foam layers 14, 16 which will be described in more detail below. The pocketed spring core 12 is mounted upon a base 18 and is completely enclosed within an upholstered covering 20. The base 18 may be any known material including a flexible sheet such as a scrim sheet or a more rigid dimensionally stabilizing substrate as described in U.S. Pat. Nos. 11,013,340 and 11,771,235, which are each incorporated by reference herein.

As shown in FIG. 1, fully assembled, the product 10 has a length “L” defined as the linear distance between opposed end surfaces 22 (only one being shown in FIG. 1). Similarly, the assembled product 10 has a width “W” defined as the linear distance between opposed side surfaces 24 (only one being shown in FIG. 1). In the product shown in FIG. 1, the length is illustrated as being greater than the width. However, it is within the scope of the present invention that the length and width may be identical, as in a square product.

As shown in FIG. 1, the pocketed spring core 12 is manufactured from multiple strings 26 of pocketed springs 28 joined together. Although strings 26 of pocketed springs 28 are shown as extending transversely or from side-to-side, they may extend longitudinally or from head-to-foot along the full length of the product 10. The pocketed spring core 12 may be any known pocketed spring core and is not intended to be limited by the drawings.

FIG. 1A illustrates a single-sided mattress 10a identical to the mattress 10 of FIG. 1 but with foam core 30 in place of the pocketed spring core 12. Although a base is not shown, it is within the scope of the present invention that a base be secured to the foam core 30.

FIG. 1B illustrates a double-sided mattress 10b having a pocketed spring core 12 as its core. However, the mattress 10b of FIG. 1B has convoluted foam layers 14, 16 above and below the pocketed spring core 12. The pocketed spring core 12 comprises a plurality of strings 26 extending from side to side or transversely. However, the transversely extending strings could be longitudinally extending or extend from head-to-foot. A foam core may be used in place of the pocketed spring core 12 in such a double-sided mattress or product.

FIG. 1C illustrates a single-sided mattress 10c comprising a pocketed spring core 12. Mattress 10c of FIG. 1C has convoluted foam layers 14c, 16c above the pocketed spring core 12 but is otherwise identical to mattress 10 of FIG. 1. Convoluted foam layers 14c, 16c differ from convoluted foam layers 14, 16 in that the rounded peaks and rounded valleys extend longitudinally in convoluted foam layers 14c, 16c, as opposed to extending transversely or from side-to-side in convoluted foam layers 14, 16. The rounded peaks and rounded valleys of convoluted foam layers 14c, 16c are shown as extending linearly or in a straight line, as are the rounded peaks and rounded valleys of convoluted foam layers 14, 16. For purposes of this document, a convoluted foam piece having these straight rounded peaks and valleys will be referred to as “furrowed”.

FIG. 1D illustrates a double-sided mattress 10d comprising pocketed spring core 12, the same as in the mattress 10 of FIG. 1. The mattress 10d of FIG. 1D is identical to mattress 10c of FIG. 1C but has a second set of convoluted foam layers 14c, 16c.

In any of the bedding or seating products shown or described herein, including mattresses 10, 10a, 10b, 10c, 10d and 10e, either a foam core 30 or any known pocketed spring core may be used as the core of the product. The drawings are not intended to be limiting.

FIG. 2 illustrates an enlarged portion of convoluted foam layers 14, 16 before being nested together. FIG. 2A illustrates an enlarged portion of convoluted foam layers 14, 16 nested together. Outer convoluted foam layer 16 has a flat or planar outer surface 32 and a plurality of rounded peaks 34 and rounded valleys 36 on a convoluted surface 38. Similarly, inner convoluted foam layer 14 has a flat or planar surface 40 and a convoluted opposite surface 42 having a plurality of rounded peaks 44 and rounded valleys 46.

The linear distance “D” between adjacent rounded peaks of either convoluted foam layer 14, 16 may be between 1-6 inches but is preferably between 2-4 inches. The linear distance “E” between an adjacent peak and valley is preferably between 0.5 to 6.0 inches. The overall height “H” of one of the convoluted pieces 14, 16 may be between 2-4 inches with the base “B” being between 1-3 inches. In one embodiment, the height H of a convoluted foam piece is 3 inches and the base 2 inches.

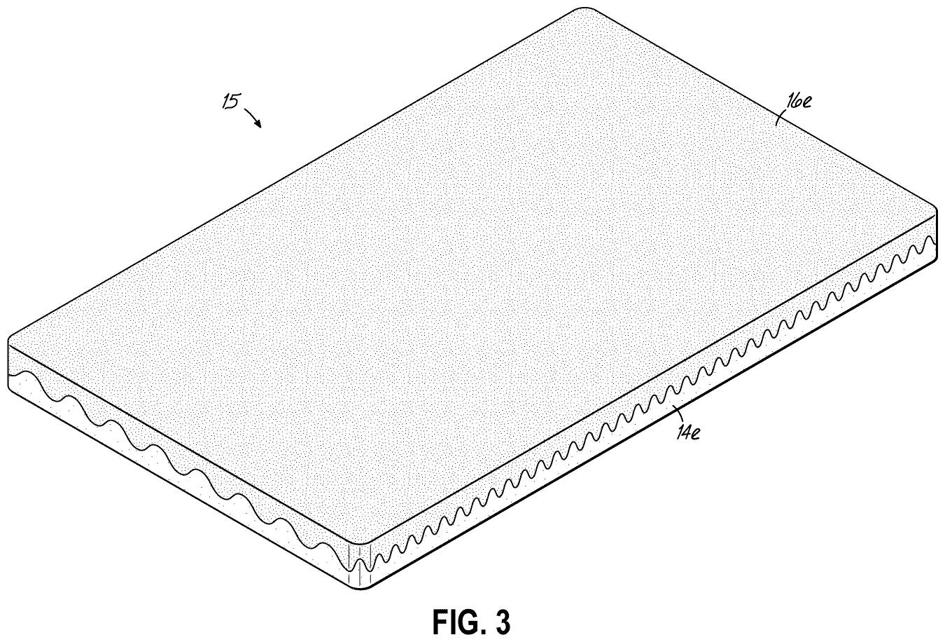

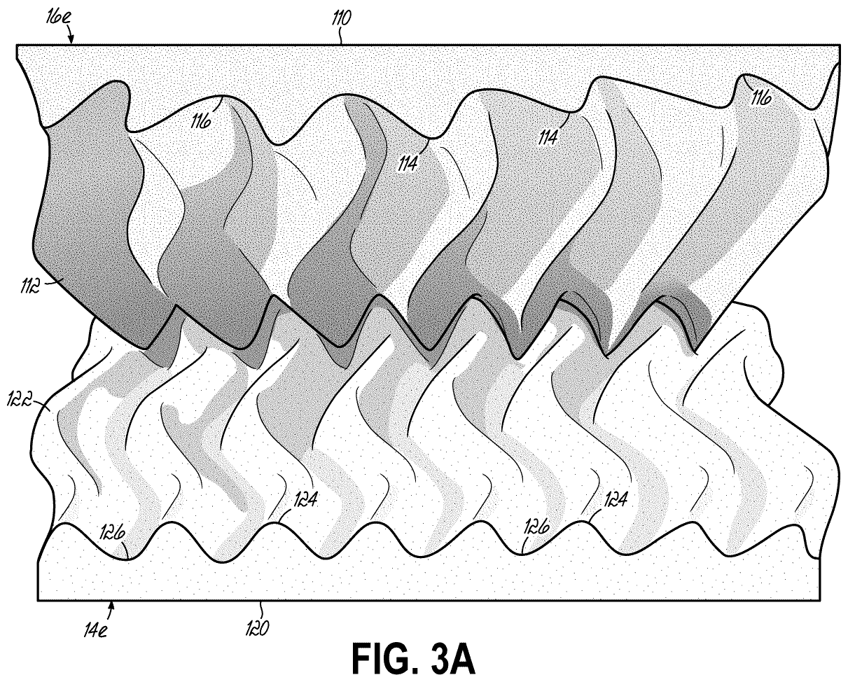

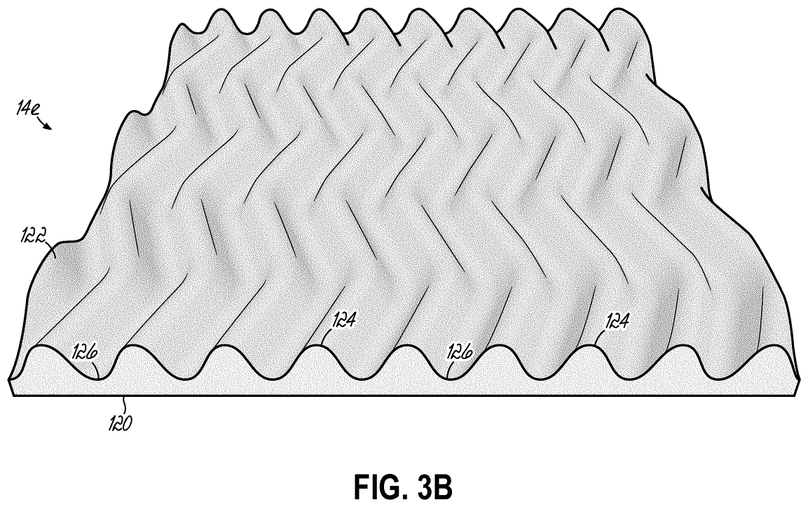

FIG. 3 illustrates a cushion 15 comprising first and second convoluted foam layers 14e, 16e. The first convoluted foam layer 14e may be made of the same foam or a different foam than the second convoluted foam layer 16e. This cushion 15 may be used in any of the bedding or seating products shown or described herein. Each of the convoluted foam layers 14e, 16e, instead of having straight rounded peaks and valleys on one side thereof, has rounded peaks and rounded valleys in a zig-zag shape on one side thereof. The rounded peaks and rounded valleys of foam pieces 14e and 16e of foam layers 14e, 16e nest together, either in a transverse direction (from side-to-side) or in a longitudinal direction (from end to end). Each of the rounded peaks and rounded valleys is zig-zag shaped or wave-shaped along its length, rather than linear. The zig-zag shaped rounded peaks and valleys may be any desired size and are not intended to be limited by the drawings.

As best shown in FIG. 3A, outer foam layer 16e has a flat outer surface 110 and a convoluted inner surface 112 comprising rounded peaks 114 and rounded valleys 116 extending in a wave or zig-zag configuration. Similarly, inner foam layer 14e has a flat outer surface 120 and a convoluted inner surface 122 comprising rounded peaks 124 and rounded valleys 126 extending in a wave or zig-zag configuration. As best shown in FIGS. 3 and 3A, despite their wave or zig-zag configuration, the rounded peaks 114 and rounded valleys 116 of outer foam layer 16e nest inside the rounded valleys 126 and rounded peaks 124 of inner foam layer 14e.

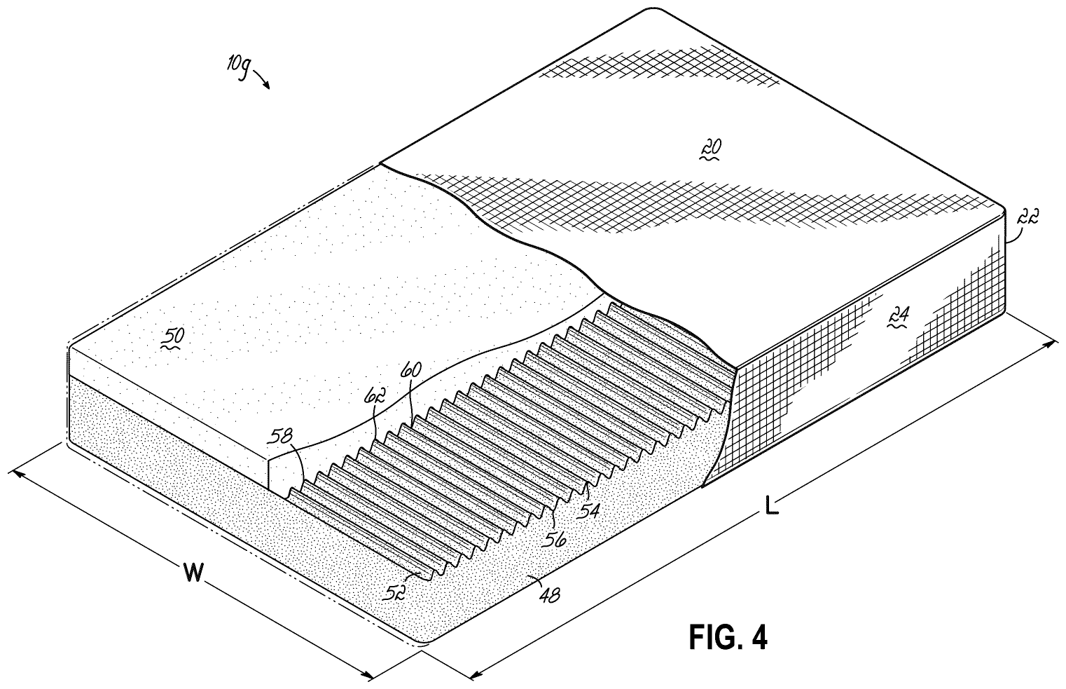

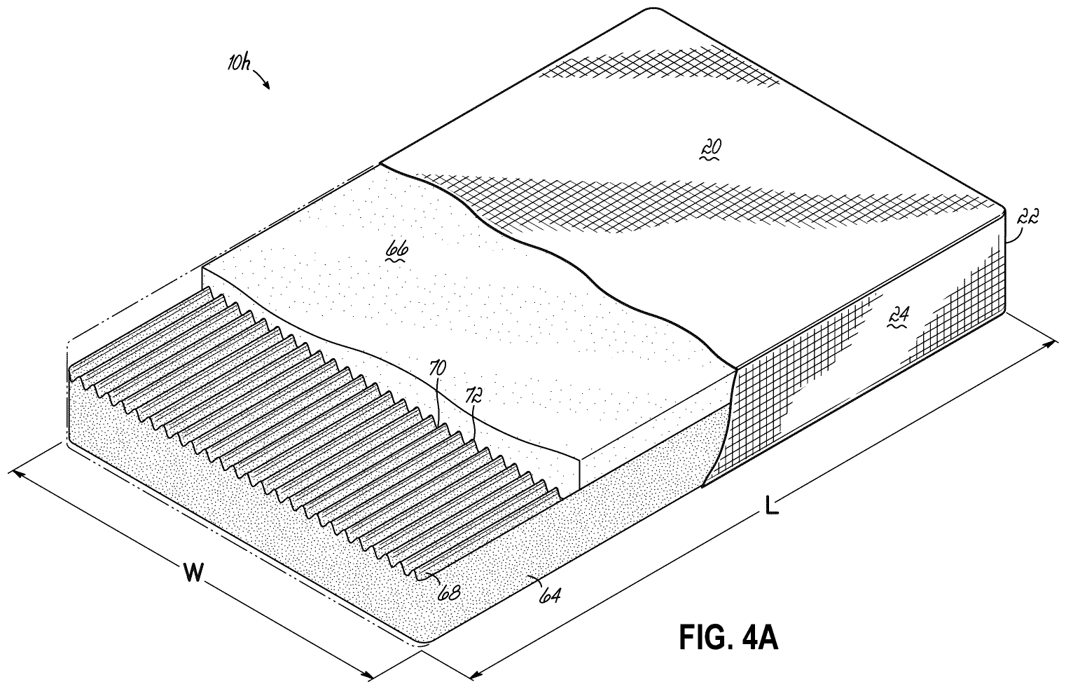

FIG. 4 illustrates another embodiment of mattress 10g which comprises a lower foam layer 48 and an upper foam layer 50 encased in a cover 20. The lower foam piece 48 has a convoluted upper surface 52 comprising linear rounded peaks 54 and linear rounded valleys 56 extending in a transverse or side-to-side direction. The upper foam layer 50 has a convoluted lower surface 58 comprising linear rounded peaks 60 and linear rounded valleys 62 extending in a transverse or side-to-side direction. The rounded peaks and rounded valleys of foam layers 48 and 50 nest together, as shown. Although not shown, each of the rounded peaks and rounded valleys of foam layers 48, 50 may be zig-zag shaped or wave-shaped along its length, rather than linear. Although not shown, one or more conventional pieces of foam may be on top of the upper foam piece 50 and inside cover 20. Although lower foam layer 48 is shown being thicker than upper foam layer 50, these foam layers may be the same size or any desired size. The drawings are not intended to be limiting.

FIG. 4A illustrates another embodiment of mattress 10h, similar to mattress 10g of FIG. 4, but having different convoluted lower and upper foam layers 64, 66. The lower foam layer 64 has a convoluted upper surface 68 comprising linear rounded peaks 70 and linear rounded valleys 72 extending in a longitudinal or end-to-end direction. The upper foam layer 66 has a convoluted lower surface 74 comprising linear rounded peaks 76 and linear rounded valleys 78 extending in a longitudinal or end-to-end direction. The rounded peaks and rounded valleys of foam layers 64 and 66 nest together, as shown. Although not shown, each of the rounded peaks and rounded valleys of foam layers 64, 66 may be zig-zag shaped or wave-shaped along its length, rather than linear. Although not shown one or more conventional pieces of foam may be on top of the upper foam piece 66 and inside cover 20. Although lower foam layer 64 is shown being thicker than upper foam layer 66, these foam layers may be the same size or any desired size. The drawings are not intended to be limiting.

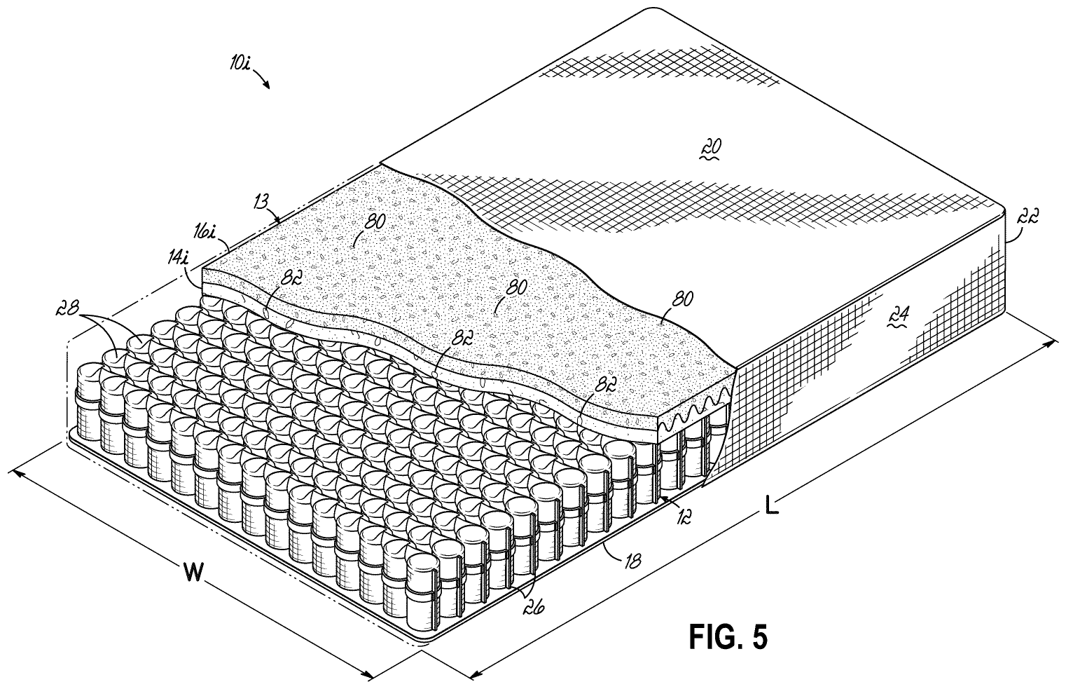

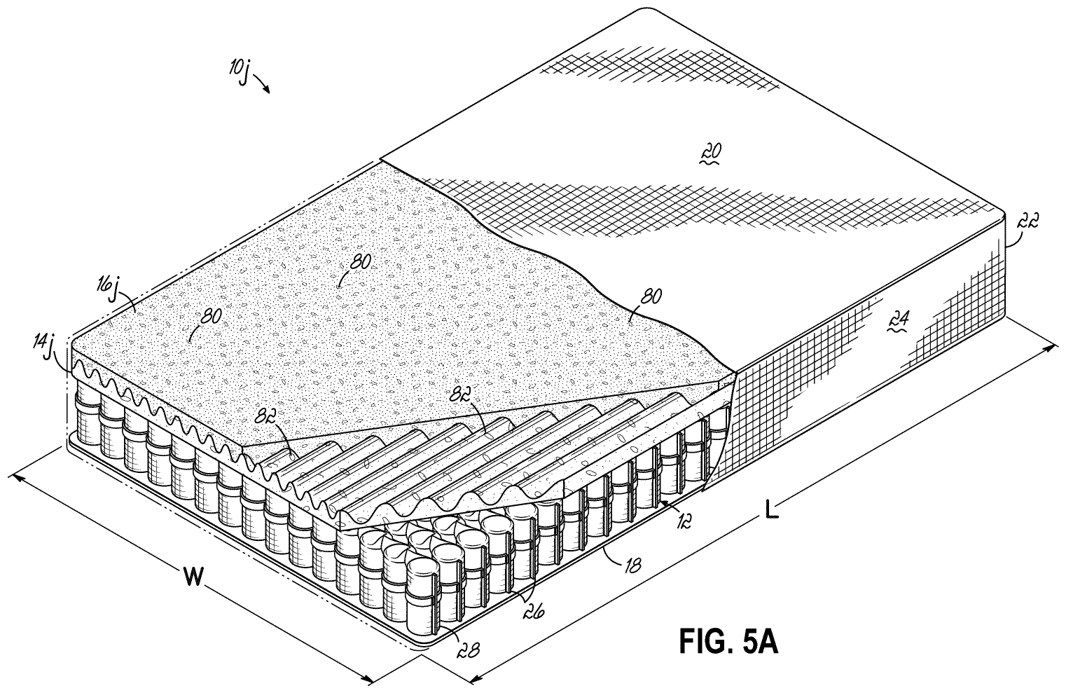

FIG. 5 illustrates another embodiment of mattress 10i having different convoluted foam layers 14i, 16i. Each of the convoluted foam layers 14i, 16i has rounded peaks and rounded valleys on one side thereof. The rounded peaks and rounded valleys of foam layers 14i and 16i nest together and extend, as shown, in a transverse direction or from side-to-side. Although each of the rounded peaks and rounded valleys is shown extending in a straight direction, each may be zig-zag shaped or wave-shaped along its length, rather than linear. The upper convoluted foam layer 16i is shown having conductive additive solids, powders, particles or flakes 80. The lower convoluted foam piece 14i as having gel capsules of phase change materials 82.

FIG. 5A illustrates another embodiment of mattress 10j, similar to mattress 10i of FIG. 3 but having different convoluted foam layers 14j, 16j. Each of the convoluted foam layers 14j, 16j has rounded peaks and rounded valleys on one side thereof. The rounded peaks and rounded valleys of foam layers 14j and 16j nest together, as shown in a longitudinal direction or from end-to-end. Each of the rounded peaks and rounded valleys may be zig-zag shaped or wave shaped along its length, rather than linear as shown. The upper convoluted foam layer 16j is shown having conductive additive solids, powders, particles or flakes 80. The lower convoluted foam layer 14j is shown having gel capsules of phase change materials 82.

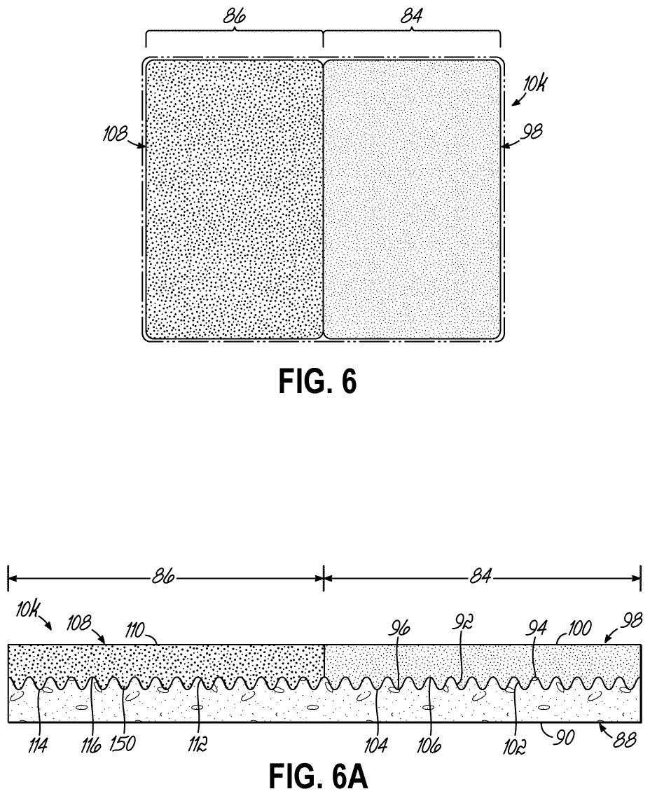

FIGS. 6 and 6A illustrate another embodiment of mattress 10k divided into first and second sections 84, 86, respectively, having different characteristics, such as firmness or cooling capability, for example. Mattress 10k comprises a base foam layer 88 having a flat bottom surface 90 and a convoluted upper surface 92 comprising rounded peaks 94 and rounded valleys 96.

Mattress 10k further comprises an upper foam piece 98 in the first section 84 having a flat upper surface 100 and a convoluted lower surface 102 comprising rounded peaks 104 and rounded valleys 106 nested with the rounded peaks 94 and rounded valleys 96 of the base foam layer 88. The foam piece 98 may be made of a different foam than the foam of the base foam layer 88.

Mattress 10k further comprises an upper foam piece 108 in the second section 86 having a flat upper surface 100 generally coplanar with the flat upper surface 100 of the adjacent upper foam piece 98. The upper foam piece 108 has a convoluted lower surface 112 comprising rounded peaks 114 and rounded valleys 116 nested with the rounded peaks 94 and rounded valleys 96 of the base foam layer 88. The upper foam piece 108 may be made of a different foam than the foam of the base foam layer 88 and different than the foam of the upper foam piece 98. FIGS. 6 and 6A illustrate the upper foam piece 108 having conductive additive solids, powders, particles or flakes. Although not shown upper foam piece 98 may have conductive additive solids, powders, particles or flakes. The base foam layer 88 may have phase change gel particles and/or conductive additive solids, powders, particles or flakes.

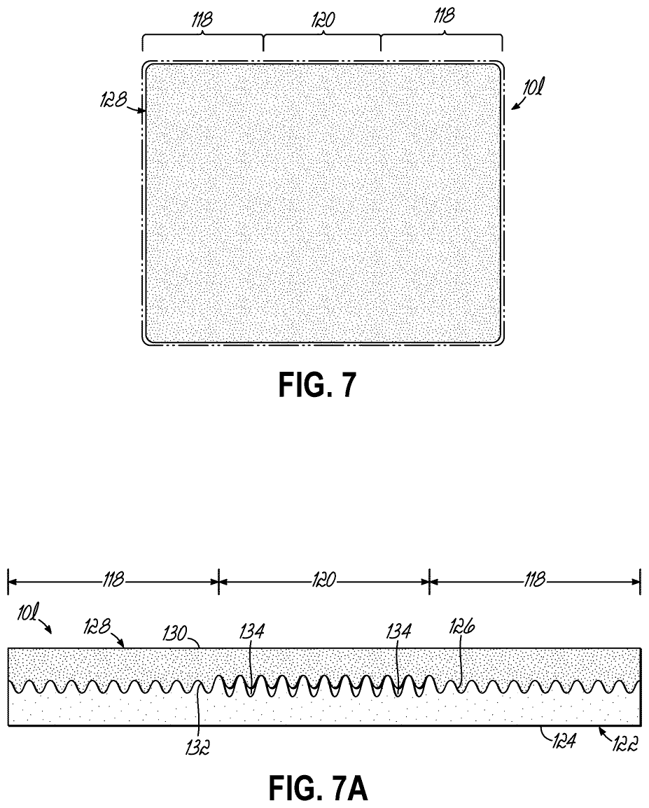

FIGS. 7 and 7A illustrate another embodiment of mattress 101 divided into two identical end sections 118 and a middle section 120, having different characteristics, such as firmness or cooling capability, for example. Mattress 101 comprises a base foam piece 122 having a flat bottom surface 124 and a convoluted upper surface 126 comprising rounded peaks and rounded valleys. The rounded peaks and rounded valleys in the middle section 120 are larger than the rounded peaks and rounded valleys of the end sections 118. Mattress 101 further comprises a top foam piece 128 having a flat upper surface 130 and a convoluted lower surface 132 comprising rounded peaks and rounded valleys. The rounded peaks and rounded valleys in the middle section 120 are smaller than the rounded peaks and rounded valleys of the end sections 118. The rounded peaks and rounded valleys of the foam pieces 122, 128 are nested such that air gaps 134 are created in only the middle section 120 of mattress 101. The air gaps 134 provide increased air flow in the middle section 120 compared to the end sections 118, resulting in a cooler sleeping surface when a load is placed thereon.

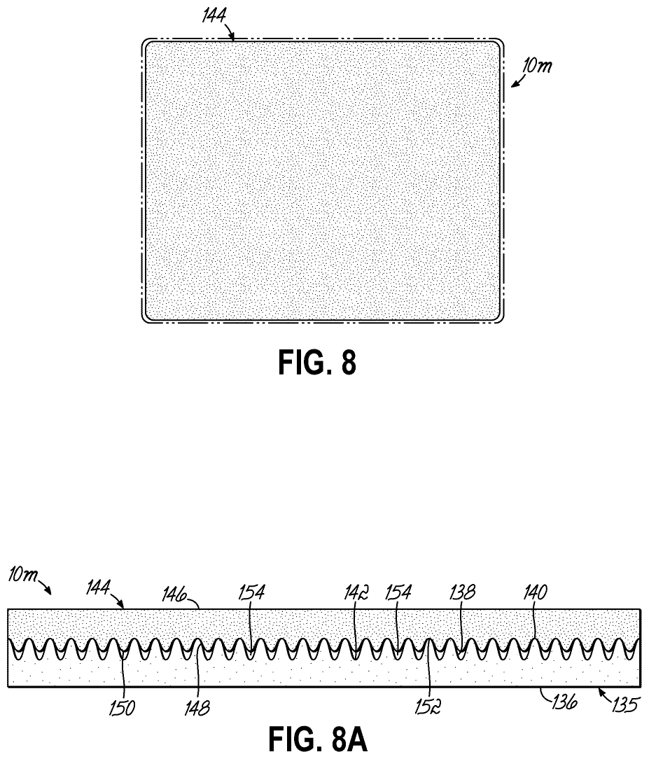

FIGS. 8 and 8A illustrate another embodiment of mattress 10m which has uniform characteristics throughout; it is not postured into sections. Mattress 10m comprises a base foam piece 135 having a flat bottom surface 136 and a convoluted upper surface 138 comprising rounded peaks 140 and rounded valleys 142. Mattress 10m further comprises a top foam piece 144 having a flat upper surface 146 and a convoluted lower surface 148 comprising rounded peaks 150 and rounded valleys 152. The rounded peaks 150 and rounded valleys 152 of the top foam piece 138 are smaller than the rounded peaks 140 and rounded valleys 142 of the base foam piece 135. The rounded peaks and rounded valleys of the foam pieces 134, 138 are nested such that air gaps 154 are created throughout the mattress 10m. The air gaps 154 provide increased air flow in the mattress 10m, resulting in a cooler sleeping surface than a mattress with no air gaps when a load is placed thereon.

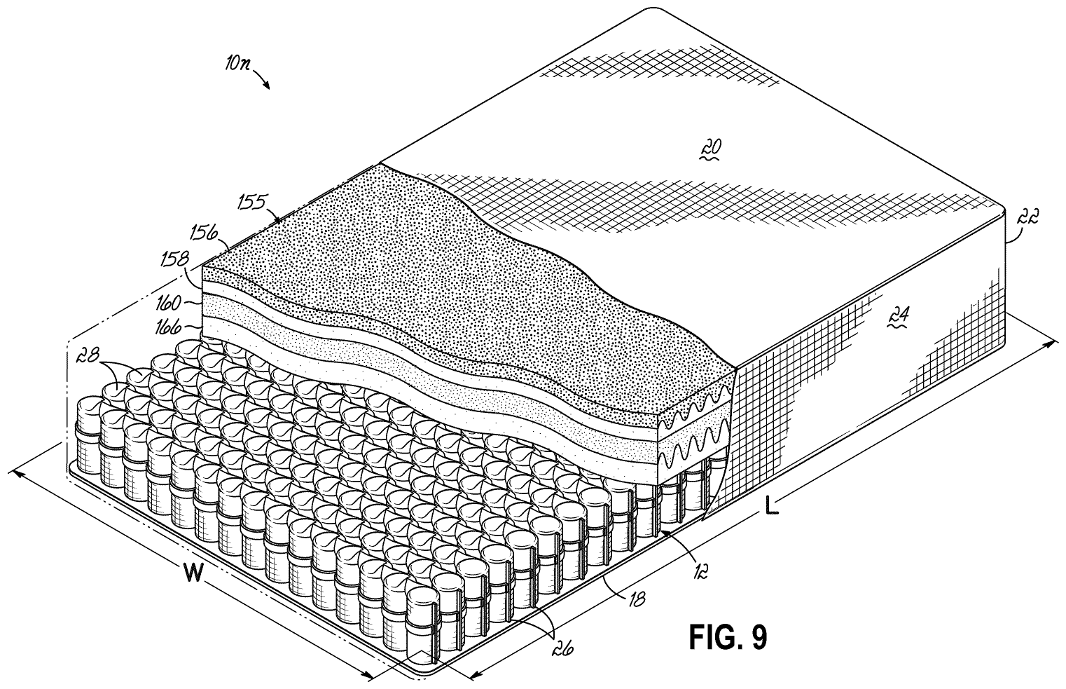

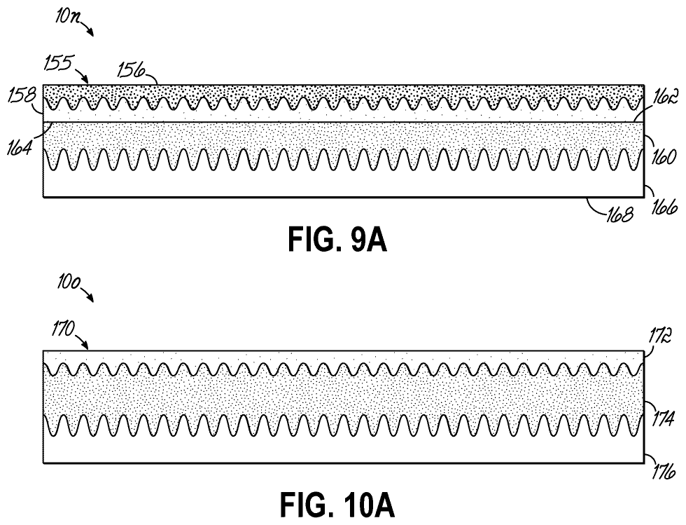

FIGS. 9 and 9A illustrate another embodiment of single-sided mattress 10n identical to mattress 10 of FIG. 1 but having a different foam construction 155 above the pocketed spring core 12. As best shown in FIG. 9A, the foam construction 155 comprises an upper layer of foam 156 being nested with a second layer of foam 158 in accordance with the principles of the present invention. Additionally, a third layer of foam 160 is underneath the second layer of foam 158 with a flat surface 162 of the second layer of foam 158 abutting a flat surface 164 of the third layer of foam 160. The foam construction 155 further comprises a lower or fourth layer of foam 166 being nested with the third layer of foam 160 in accordance with the principles of the present invention. A flat surface 168 of the lower or fourth layer of foam 166 abuts the pocketed spring core 12.

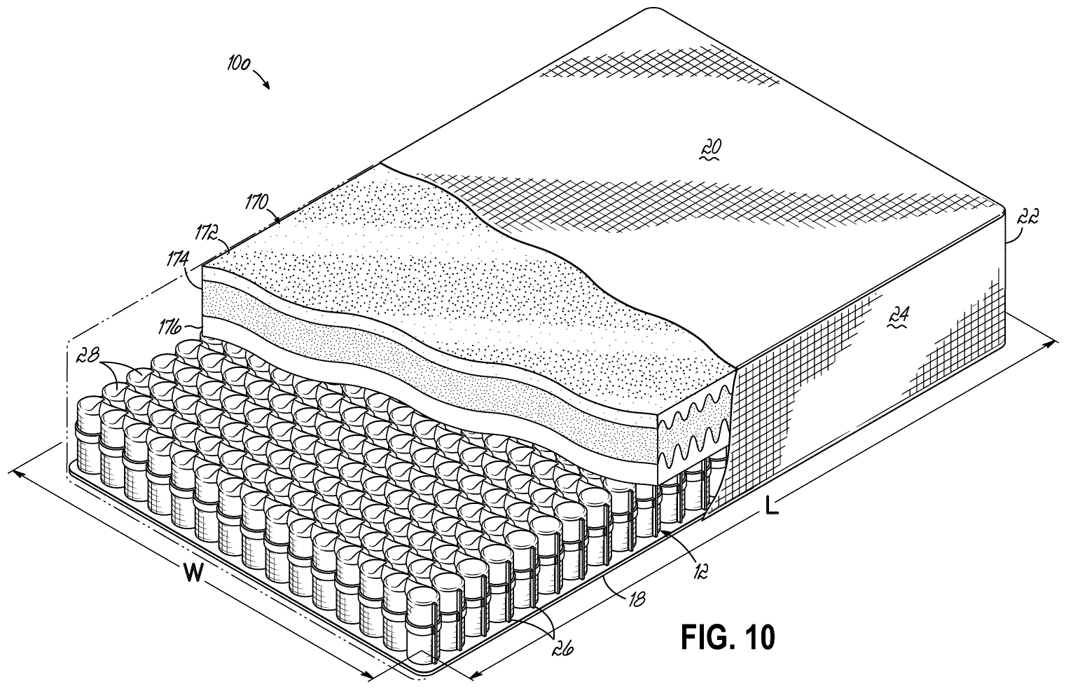

FIGS. 10 and 10A illustrate another embodiment of single-sided mattress 10o identical to mattress 10 of FIG. 1 but having a different foam construction 170 above the pocketed spring core 12. As best shown in FIG. 10A, the foam construction 170 comprises an upper layer of foam 172 being nested with a middle layer of foam 174 in accordance with the principles of the present invention. Additionally, a third or lower layer of foam 176 is underneath the middle layer of foam 174. The middle layer of foam 174 of foam construction 170 has convoluted upper and lower surfaces and is nested with the upper and lower layers of foam 172, 176 in accordance with the principles of the present invention. A flat surface 168 of the lower or third layer of foam 166 abuts the pocketed spring core 12.

Although the foam constructions or cushions 155, 170 of mattresses 10n and 10o shown in FIGS. 9 and 10, respectively, are shown used in a single-sided mattress, either foam construction or cushion 155, 170 may be used in any double-sided mattress or any mattress described or shown herein. Although the foam constructions or cushions 155, 170 of mattresses 10n and 10o shown in FIGS. 9 and 10, respectively, are shown with the rounded peaks and rounded valleys extending from side-to-side they may extend from head-to-foot or end-to-end.

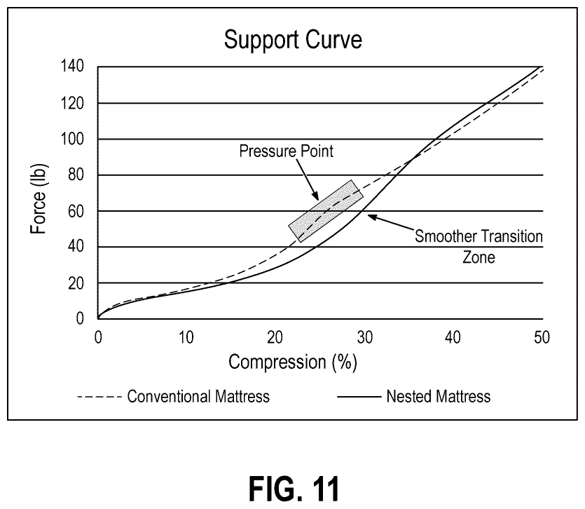

As shown in FIG. 11, mattresses constructed with nested convoluted foam layers create unique performance benefits than enhance sleep comfort. The overlap region of convolutions creates a continuously variable transition zone providing dramatically smoother support properties as the mattress is compressed under the body. The nested convolutions create an area of transition created by the convolutions. Smoother layer transitions create more uniform contouring and support properties, reduce pressure points and remove the sensation of “bottoming out” in the mattress.

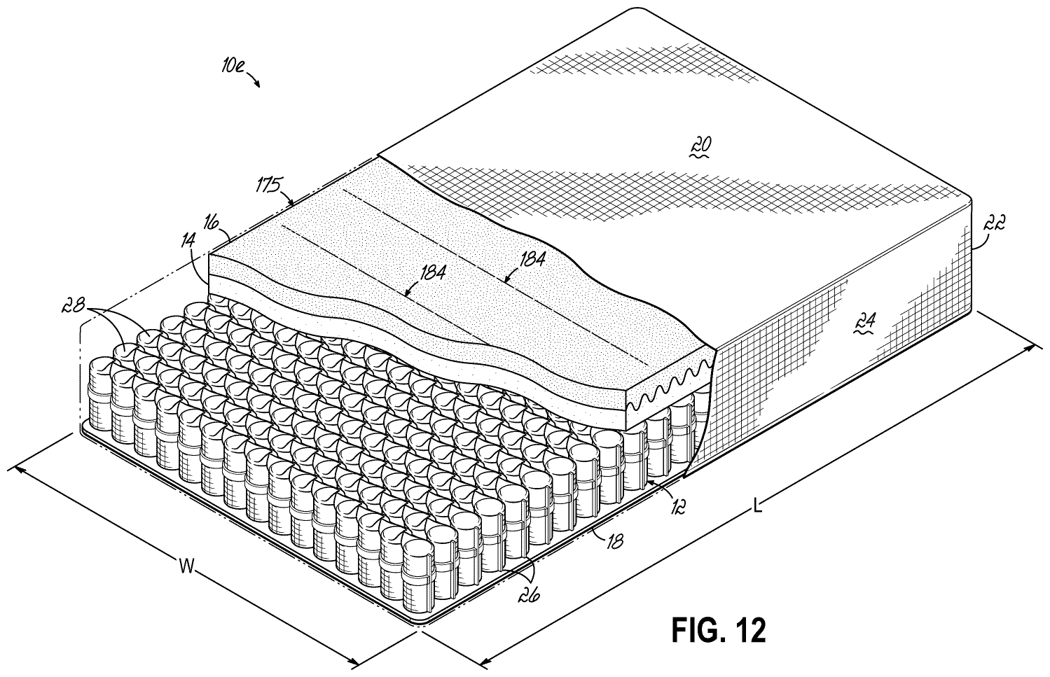

FIG. 12 shows another embodiment of mattress 10e comprising a pocketed spring core 12 over the top of which lays a quilted cushion 175. The quilted cushion 175 comprises first and second convoluted layers 16, 14 nested together and sewn together. Each of the first and second convoluted layers 16, 14 may be made of any known material including any known foam or fiber material or combination thereof. The first or inner convoluted layer 14 may be made of the same material or a different material than the second or outer convoluted layer 16. Although each convoluted layer is shown as a single piece, any of the layers may be made from multiple pieces in any embodiment shown or described herein. Quilted cushion 175 may be used in any of the bedding or seating products shown or described herein or may be sold independently.

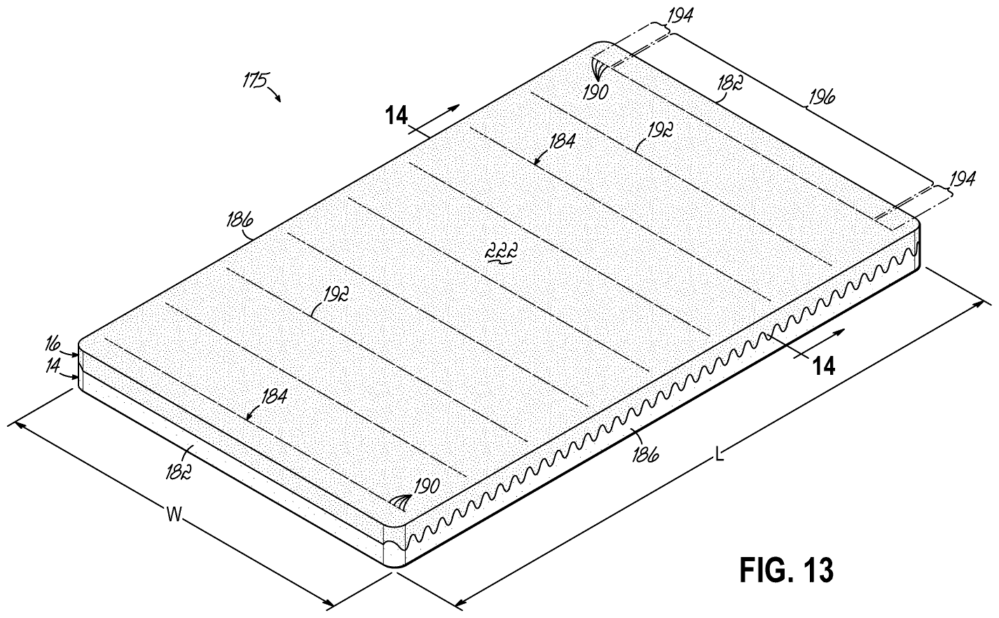

FIG. 13 illustrates quilted cushion 175 comprising first and second convoluted layers 16, 14, as described herein. The first and second convoluted layers 16, 14 are sewn together with multiple parallel spaced stitch lines 184. The quilted cushion 175 has two end surfaces 182, the linear distance between which defines the longitudinal dimension or length “L” of the quilted cushion 175. The quilted cushion 175 has two side surfaces 186, the linear distance between which defines the transverse dimension or width “W” of the quilted cushion 175.

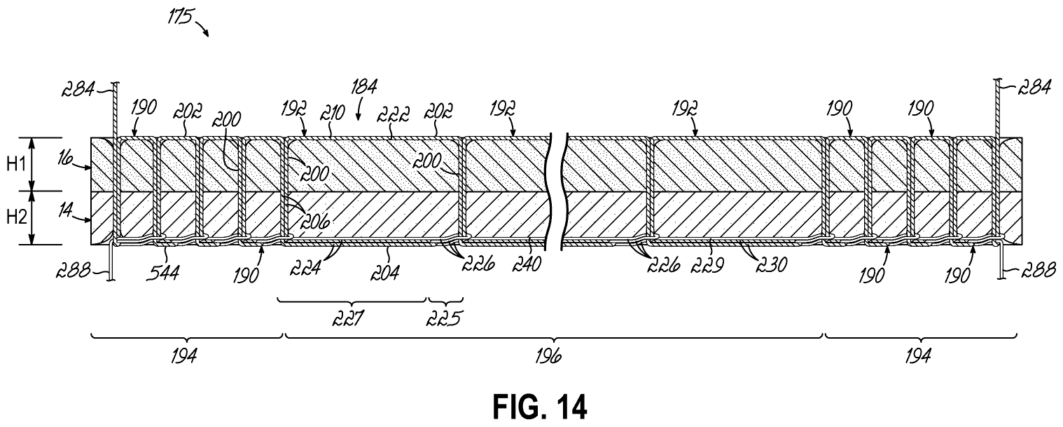

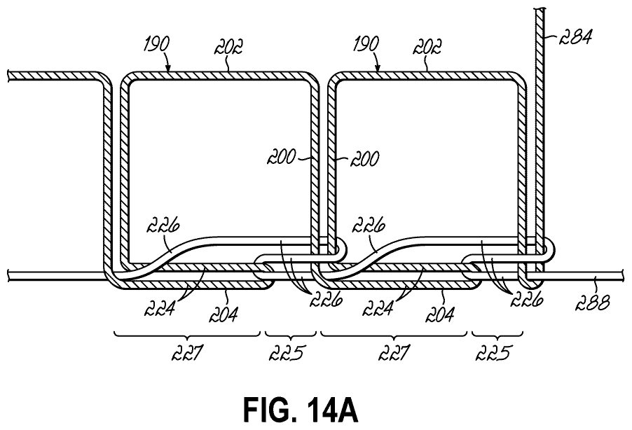

As shown in FIGS. 13 and 14, the quilted cushion 175 has an upper layer or first convoluted layer 16 shown in cross section having a height H1 and a lower or second convoluted layer 14 in cross section having a height H2. FIGS. 12, 13 and 14 illustrate multiple parallel spaced stitch lines 184 extending parallel the end surfaces 182 of the quilted cushion 175 and extending in the transverse direction. Each of the stitch lines 184 is identical and made up of short and long chain stitches 190, 192, respectively. It is within the scope of the present invention that any of the stitch lines of any of the embodiments shown or described herein may have any number of different chain stitches of any desired length or may comprise chain stitches of the same length, as described in U.S. Pat. Nos. 11,015,274 and 11,015,275. For example, short chain stitches may be on opposite sides of long chain stitches in the stitch lines or versa visa. It is further within the scope of the present invention that not the stitch lines within any cushion shown or described herein not be identical but rather at least two stitch lines be different.

FIG. 14 best illustrates short and long chain stitches 190, 192, respectively, of stitch lines 184 holding the layers 16, 14 of quilted cushion 175 together. No adhesive is necessary. Each of the stitch lines 184 comprises multiple short chain stitches 190 comprising a side section 194 at each side of the quilted cushion 175. Each of the stitch lines 184 further comprises multiple long chain stitches 192 comprising a middle section 196 between the side sections 194 of each stitch line 184 of the quilted cushion 175.

As best shown in FIG. 14A and described in U.S. Pat. Nos. 11,015,274 and 11,015,275, each chain stitch, shown as short chain stitches 190 comprises two sides 200, a top 202 and a bottom 204. Each side 200 comprises one section 206 of a needle thread 284. The side 200 of one chain stitch 190 abuts the side of an adjacent chain stitch 190, except for the outermost side of each outermost short chain stitch 190.

As best seen in FIGS. 14 and 14A, the top 202 of each chain stitch 190, comprises a single section 210 of needle thread 284 which extends across an upper surface 222 of the quilted cushion 175. The bottom 204 of each chain stitch 190 comprises two portions, a short portion 225 comprising three sections 226 of looper thread 288 and a long portion 227 comprising one section 229 of looper thread 288 and two sections 230 of needle thread 284. Each of the short and long portions 225, 227 of bottom 204 of each short chain stitch 190 extends below a lower surface 240 of the quilted cushion 175. Although FIG. 14A illustrates three short chain stitches 190, the composition of the chain stitch is the same regardless of the size/length of the chain stitch.

The linear distance between the opposed sides 200 of a long chain stitch 192 is greater than the linear distance between the opposed sides 200 of a short chain stitch 190. Similarly, the length of the top 202 and bottom 204 of a long chain stitch 192 is greater than the length of the top 202 and bottom 204 of a short chain stitch 190.

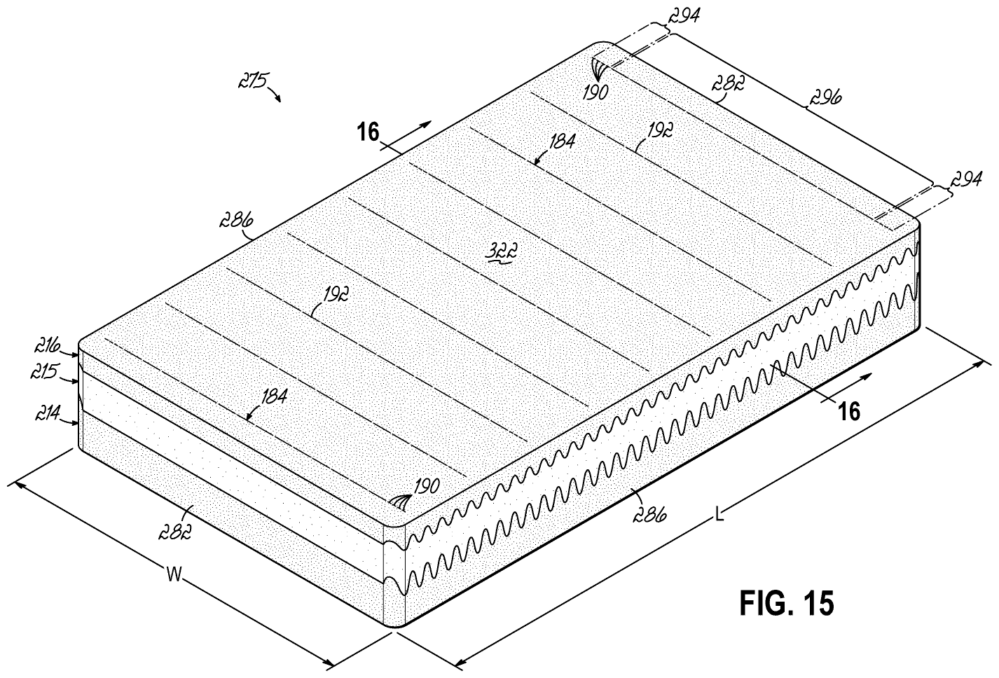

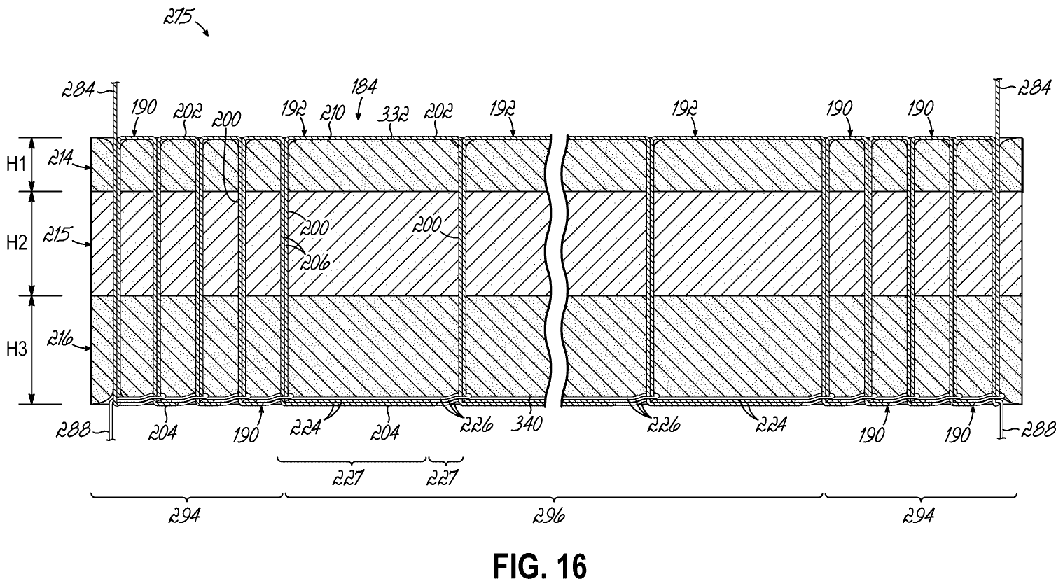

FIGS. 15 and 16 illustrate a quilted cushion 275 comprising first, second and third convoluted layers 216, 214 and 215, as described herein. The first, second and third convoluted layers 216, 214 and 215 are sewn together with multiple spaced stitch lines 184. Each of the convoluted layers may be made of any known material including any known foam or fiber material or combination thereof. The quilted cushion 275 has two end surfaces 282, the linear distance between which defines the longitudinal dimension or length “L” of the quilted cushion 275. The quilted cushion 275 has two side surfaces 286, the linear distance between which defines the transverse dimension or width “W” of the quilted cushion 275. Quilted cushion 275 may be used in any of the bedding or seating products shown or described herein or may be sold independently.

As shown in FIGS. 15 and 16, the quilted cushion 275 has an upper or first convoluted layer 216 in cross section having a height H1, a lower or second convoluted layer 214 in cross section having a height H2 and a third or middle convoluted layer 215 therebetween in cross section having a height H3. The upper convoluted layer 216 is nested with middle convoluted layer 215 in accordance with the principles of the present invention. The third or lower layer 214 is underneath middle convoluted layer 215. The middle convoluted layer 215 has convoluted upper and lower surfaces and is nested with the upper and lower layers 216, 214 in accordance with the principles of the present invention. FIGS. 15 and 16 illustrate multiple spaced stitch lines 184 extending parallel the end surfaces 282 of the quilted cushion 275 and extending in the transverse direction. Each of the stitch lines 184 may be identical and made up of short and long chain stitches 190, 192. It is within the scope of the present invention that any of the stitch lines of any of the embodiments shown or described herein may have any number of different chain stitches of any desired length or may comprise chain stitches of the same length, as described in U.S. Pat. Nos. 11,015,274 and 11,015,275. For example, short chain stitches may be on opposite sides of long chain stitches in the stitch lines or versa visa.

FIG. 16 best illustrates short and long chain stitches 190, 192, respectively, of stitch lines 184 holding the layers 216, 214 and 215 of the quilted cushion 275 together. Each of the stitch lines 184 comprises multiple short chain stitches 190 comprising an end section 294 at each end of the quilted cushion 275. Each of the stitch lines 184 further comprises multiple long chain stitches 192 comprising a middle section 296 between the end sections 294 of each stitch line 184 of the quilted cushion 275. As best shown in FIG. 16 and described in U.S. Pat. Nos. 11,015,274 and 11,015,275, each chain stitch is made with needle thread 284 and looper thread 288.

As best seen in FIG. 16, the top 202 of each chain stitch 190, 192 comprises a single section 210 of needle thread 284 which extends across an upper surface 322 of the quilted cushion 275. The bottom 204 of each chain stitch 190, 192 extends below a lower surface 340 of the quilted cushion 175. The chain stitches 190, 192 are as described herein and described in U.S. Pat. Nos. 11,015,274 and 11,015,275.

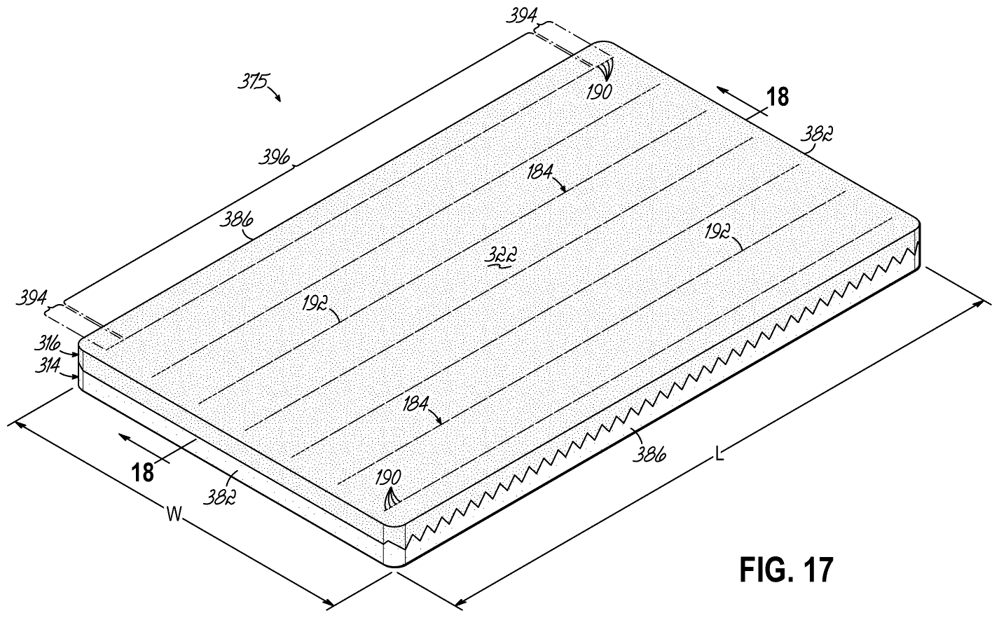

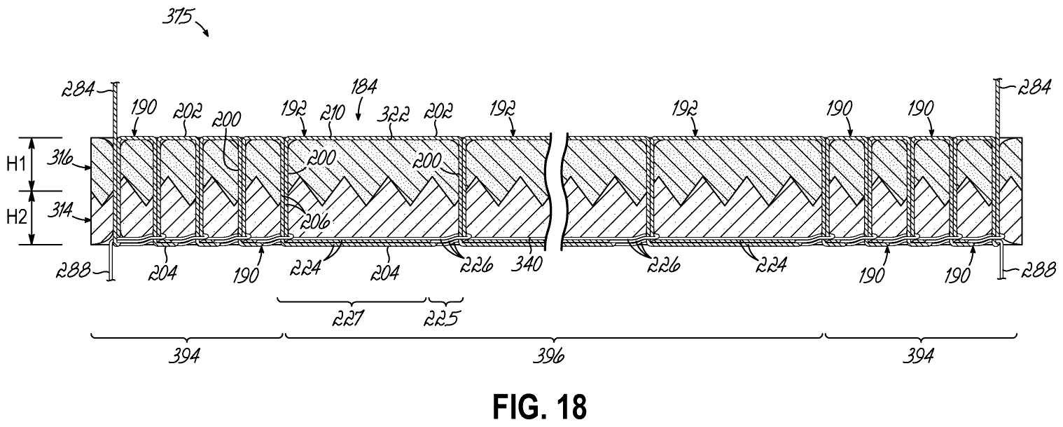

FIGS. 17 and 18 illustrate a quilted cushion 375 comprising first and second convoluted layers 316 and 314, as described herein. The first and second convoluted layers 316 and 314 are sewn together with multiple spaced stitch lines 184. Each of the convoluted layers may be made of any known material including any known foam or fiber material or combination thereof. The quilted cushion 375 has two end surfaces 382, the linear distance between which defines the longitudinal dimension or length “L” of the quilted cushion 375. The quilted cushion 375 has two side surfaces 386, the linear distance between which defines the transverse dimension or width “W” of the quilted cushion 375. Quilted cushion 375 may be used in any of the bedding or seating products shown or described herein or may be sold independently.

As shown in FIGS. 17 and 18, the quilted cushion 375 has an upper or first convoluted layer 316 in cross section having a height H1 and a lower or second convoluted layer 214 in cross section having a height H2. The upper convoluted layer 316 is nested with the lower convoluted layer 314 in accordance with the principles of the present invention. FIGS. 17 and 18 illustrate multiple spaced stitch lines 184 extending parallel the side surfaces 386 of the quilted cushion 375 and extending in the longitudinal direction. Each of the stitch lines 184 may be identical and made up of short and long chain stitches 190, 192. Alternatively, at least two of the stitch lines 184 may differ from each other. It is within the scope of the present invention that any of the stitch lines of any of the embodiments shown or described herein may have any number of different chain stitches of any desired length or may comprise chain stitches of the same length, as described in U.S. Pat. Nos. 11,015,274 and 11,015,275. For example, short chain stitches may be on opposite sides of long chain stitches in the stitch lines or versa visa.

FIG. 18 best illustrates short and long chain stitches 190, 192, respectively, of stitch lines 184 holding the layers 316 and 314 of the quilted cushion 375 together. Each of the stitch lines 184 comprises multiple short chain stitches 190 comprising an end section 394 at each end of the quilted cushion 375. Each of the stitch lines 184 further comprises multiple long chain stitches 192 comprising a middle section 396 between the end sections 394 of each stitch line 184 of the quilted cushion 375. As best shown in FIG. 16 and described in U.S. Pat. Nos. 11,015,274 and 11,015,275, each chain stitch is made with needle thread 284 and looper thread 288.

As best seen in FIG. 18, the top 202 of each chain stitch 190, 192 comprises a single section 210 of needle thread 284 which extends across an upper surface 322 of the quilted cushion 375. The bottom 204 of each chain stitch 190, 192 extends below a lower surface 340 of the quilted cushion 375. The chain stitches 190, 192 are as described herein and described in U.S. Pat. Nos. 11,015,274 and 11,015,275.

As best shown in FIG. 18, the peaks and valleys of the convoluted surfaces of pieces or layers 316, 314 may be pointed, rather than rounded. The peaks and valleys of any of the convoluted surfaces of any of the cushions or products shown or described herein may be pointed, rather than rounded. Such an arrangement, viewed from one side, presents the appearance of nested triangles.

The various embodiments of the invention shown and described are merely for illustrative purposes only, as the drawings and the description are not intended to restrict or limit in any way the scope of the claims. Those skilled in the art will appreciate various changes, modifications, and improvements which can be made to the invention without departing from the spirit or scope thereof. The invention in its broader aspects is therefore not limited to the specific details and representative apparatus and methods shown and described. Departures may therefore be made from such details without departing from the spirit or scope of the general inventive concept. The invention resides in each individual feature described herein, alone, and in all combinations of any and all of those features. Accordingly, the scope of the invention shall be limited only by the following claims and their equivalents.

What is claimed is:

1. A bedding or seating product comprising:
a pocketed spring core;
a first piece of foam having a flat surface proximate the pocketed spring core and peaks and valleys on the opposite side from the flat surface; and
a second piece of foam having peaks and valleys nested with the peaks and valleys of the first piece of foam,
wherein the first and second pieces of foam are sewn together.

2. The product of claim 1 wherein the peaks and valleys are straight.

3. The product of claim 1, wherein at least one of the first and second pieces of foam contains at least one of the following additives: phase change materials, plant-based fibers, synthetic fibers, fragrances, slow-release fragrances, organic and inorganic antimicrobial additives, color additives, thermochromic materials, conductive additive solids, powders, particles, flakes, density reducing agents or gas generating materials.

4. The product of claim 1, wherein one of the first and second pieces of foam has a different firmness than other of the first and second pieces of foam.

5. The product of claim 1, wherein the first and second pieces of foam are made of different foams.

6. The product of claim 1, wherein at least one of the first and second pieces of foam contains conductive additive solids, powders, particles or flakes.

7. The product of claim 1, wherein the peaks and valleys of at least one of the first and second pieces of foam have different heights.

8. A bedding or seating product comprising:
a core;
a first piece of foam having a flat surface proximate the pocketed spring core and rounded peaks and rounded valleys on the opposite side from the flat surface, the rounded peaks and rounded valleys extending in a wave shape; and
a second piece of foam having rounded peaks and rounded valleys nested with the rounded peaks and rounded valleys of the first piece of foam,
wherein the first and second pieces of foam are sewn together.

9. The product of claim 8, wherein the first and second pieces of foam are made of different foams.

10. The product of claim 8, wherein one of the first and second pieces of foam has a different firmness than other of the first and second pieces of foam.

11. The product of claim 8, wherein at least one of the first and second pieces of foam contains conductive additive solids, powders, particles or flakes.

12. The product of claim 8, wherein at least one of the first and second pieces of foam contains at least one of the following additives: phase change materials, plant-based fibers, synthetic fibers, fragrances, slow-release fragrances, organic and inorganic antimicrobial additives, color additives, thermochromic materials, conductive additive solids, powders, particles, flakes, density reducing agents or gas generating materials.

13. The product of claim 8, wherein the rounded peaks and rounded valleys of one of the first and second pieces of foam are of a first height and the rounded peaks and rounded valleys of one of the other of the first and second pieces of foam are of a second height different than the first height.

14. The product of claim 8, wherein the rounded peaks and rounded valleys of the first and second pieces of foam are identical in cross-section.

15. A bedding or seating product comprising:
a first piece of foam having a flat surface and rounded peaks and rounded valleys on the opposite side from the flat surface; and
a second piece of foam having rounded peaks and rounded valleys nested with the rounded peaks and rounded valleys of the first piece of foam,
wherein the first and second pieces of foam are sewn together.

16. The product of claim 15, wherein at least one of the first and second pieces of foam contains at least one of the following additives: phase change materials, plant-based fibers, synthetic fibers, fragrances, slow-release fragrances, organic and inorganic antimicrobial additives, color additives, thermochromic materials, conductive additive solids, powders, particles, flakes, density reducing agents or gas generating materials.

17. The product of claim 15, wherein one of the first and second pieces of foam has a different firmness than other of the first and second pieces of foam.

18. The product of claim 15, wherein the first and second pieces of foam are made of different foams.

19. The product of claim 15, wherein at least one of the first and second pieces of foam contains conductive additive solids, powders, particles or flakes.

20. The product of claim 15, wherein the rounded peaks and rounded valleys of the first piece of foam have a height different than the rounded peaks and rounded valleys of the second piece of foam.
